(19) United States
(12) Patent Application Publication
(10) Pub. No.: US 2026/0230421 A1
(43) Pub. Date: Aug. 6, 2026

(54) Loop Detection and Prevention in Multi-Protocol Routing Environment

(71) Applicant: Ciena Corporation, Hanover, MD (US)

(72) Inventors: Ghulam Mustafa, Aligarh (IN); Gagan Garg, Gurgaon (IN)

(73) Assignee: Ciena Corporation, Hanover, MD (US)

(21) Appl. No.: 19/083,835

(22) Filed: Mar. 19, 2025

(30) Foreign Application Priority Data
Jan. 31, 2025 (IN) 202541008244

(51) Int. Cl. H04L 45/18; H04L 43/106; H04L 45/02; H04L 45/52

(52) U.S. Cl. CPC H04L 45/18; H04L 43/106; H04L 45/04; H04L 45/52

(57) ABSTRACT

A method, implemented at a provider edge (PE) router, for detecting and preventing routing loops in a network with a multi-protocol routing environment, includes steps of defining a unique loop detection route that is either unused as a route in the network or has a prefix that is non-overlapping with any other route in the network; redistributing a set of routes, including the unique loop detection route, into another routing protocol, thereby attaching loop prevention metadata to the redistributed routes; receiving, from a customer edge (CE) router, at least one route that was previously redistributed into a third routing protocol; and identifying, upon a match of the unique loop detection route with the at least one route, that a routing loop condition exists due to a loss of the loop prevention metadata in the third routing protocol.

### FIELD OF THE DISCLOSURE

The present disclosure relates generally to networking and computing. More particularly, the present disclosure relates to systems and methods for loop detection and prevention for multi-protocol routing environments.

### BACKGROUND OF THE DISCLOSURE

RFC 4577, “OSPF as the Provider/Customer Edge Protocol for BGP/MPLS IP Virtual Private Networks (VPNs),” June 2006, the contents of which are incorporated by reference in their entirety, defines the use of the open shortest path first (OSPF) protocol as a provider edge (PE)-customer edge (CE) protocol for multiprotocol label switching (MPLS) VPNs. This standard details the necessary extensions and procedures to ensure that OSPF operates effectively in the VPN context, facilitating routing information exchange between the service provider's network and multiple customer networks. Through these guidelines, providers can leverage OSPF to maintain scalable, logically isolated routing domains while still taking advantage of MPLS mechanisms, ultimately promoting efficient, robust, and secure connectivity in large-scale VPN deployments. However, there is a scenario where an intermediate routing domain, between the PE and the CE, referred to as a third routing domain in RFC 4577, can cause loss of loop prevention information, thereby causing possible loops. This is described in details in Section 4.2.5.3 of RFC 4577.

### BRIEF SUMMARY OF THE DISCLOSURE

The present disclosure relates to systems and methods for loop detection and prevention for multi-protocol routing environments. One of the key challenges highlighted in Section 4.2.5.3 of RFC 4577 concerns the loss of loop prevention information, such as the Down (DN) bit or the route tag, when a network is interconnected by a third routing domain—for instance, routing information protocol (RIP). In many VPN deployments, OSPF routes from a PE to a CE are marked with a DN bit or a route tag to signal that they should not be readvertised back into the MPLS VPN core (or another routing domain) in a way that could create loops. However, if an intermediate domain like RIP does not preserve or pass along the DN bit or the route tag, that potentially critical information effectively disappears when the route transitions through the RIP network. Because the loop prevention flag gets stripped, the receiving OSPF domain (or the MPLS VPN core) cannot detect that the route was previously advertised out of its domain. Consequently, the route might be “looped” back into the network. This reintroduction of a route without its necessary loop prevention identifiers can lead to continuous, circular route advertisement and, ultimately, disrupt the entire VPN's stability.

The present disclosure addresses this gap to maintain reliable loop prevention, so that these markers remain intact or are otherwise accounted for even when routes pass through legacy or less sophisticated routing protocols. Specifically, a proposed enhancement addresses the loss of loop prevention information by defining a unique loop detection route or prefix within border gateway protocol (BGP) and prescribing a decision-making process for provider edge (PE) routers to identify loops created by intermediate routing domains (e.g., RIP). Upon detecting a loop, the PE router takes specific actions to break it and prevent further propagation of invalid routes. This solution not only augments RFC 4577 to provide robust loop prevention but also provides a general framework that can be applied to other routing scenarios in addition to RFC 4577, offering improved network stability and resilience.

In various embodiments, the present disclosure contemplates implementation as a method with steps, via a PE router configured to implement the steps, and as a non-transitory computer-readable medium storing instructions that, when executed, cause circuitry to implement the steps. The steps are for detecting and preventing routing loops in a multi-protocol network environment. The steps include defining a unique loop detection route that is either unused as a route in the network or has a prefix that is non-overlapping with any other route in a network; redistributing a set of routes, including the unique loop detection route, into another routing protocol; receiving, from a customer edge (CE) router, at least one route that was previously redistributed into a third routing protocol; and identifying, upon a match of the unique loop detection route with the at least one route, that a routing loop condition exists due to a loss of the loop prevention metadata in the third routing protocol.

The steps can further include generating an alert upon identifying the routing loop condition, wherein the alert is: a Syslog message; a simple network management protocol (SNMP) trap; a telemetry notification; or an event log. The steps can further include suspending redistribution into a border gateway protocol (BGP) virtual private network (VPN) backbone upon identifying the routing loop condition, thereby preventing recirculation of looped routes. The steps can further include re-enabling redistribution of routes into the BGP VPN backbone once the looped routes clear, wherein clearing is determined by an absence of the unique loop detection route in subsequent route updates from the CE router, for a predetermined or configurable time duration. The loop prevention metadata attached in another routing protocol can include at least one of: a Down (DN) bit in Open Shortest Path First (OSPF); a VPN route tag; or any other loop prevention information.

The third routing protocol through which the loop prevention metadata is lost can be one of: border gateway protocol (BGP), routing information protocol (RIP), interior gateway routing protocol (IGRP), enhanced interior gateway routing protocol (EIGRP) in configurations that do not preserve the loop prevention metadata, or a proprietary or legacy distance-vector protocol lacking support for the loop prevention metadata. The steps can further include automatically deriving the unique loop detection route from existing border gateway protocol (BGP) configuration parameters on the PE router, thereby eliminating manual configuration of the prefix. The steps can further include recording the routing loop condition in a data store accessible by a network management system, wherein the recording includes at least a timestamp, an identifier of the detecting PE router, and an indication of the unique loop detection route. Identifying the routing loop condition can further include detecting an absence or alteration of the loop prevention metadata on the at least one route when it is received from the CE router, for a predetermined or configurable time duration. The steps can further include applying the defined unique loop detection route and loop prevention metadata to multiple routing protocols concurrently, such that each protocol's redistributed routes are checked for the unique loop detection prefix.

### BRIEF DESCRIPTION OF THE DRAWINGS

The present disclosure is detailed through various drawings, where like components or steps are indicated by identical reference numbers for clarity and consistency.

FIG. 1 illustrates a network with PE routers and CE routers for illustrating different routing domains along with losing loss prevention information between routing domains.

FIG. 2 illustrates the network of FIG. 1 showing the loop prevention problem with the intermediate RIP domain.

FIG. 3 is a flowchart of a process detailing associated steps for loop prevention with the special loop detection route/prefix.

FIG. 4 is a flowchart of a process describing redistribution of routes and prevention of loops using the special route from the process.

FIG. 5 illustrates the network of FIGS. 1 and 2 showing the loop prevention problem with the intermediate RIP domain, along with operation of the processes of FIGS. 3 and 4, addressing loop prevention with the special route.

FIG. 6 is a flowchart of a process describing loop detection and prevention for multi-protocol routing environments.

FIG. 7 illustrates a block diagram of a PE router, depicted in a simplified functional format.

FIG. 8 illustrates a block diagram of an example processing device.

### DETAILED DESCRIPTION OF THE DISCLOSURE

Again, the present disclosure relates to systems and methods for loop detection and prevention for multi-protocol routing environments, such as in RFC 4577. RFC 4577 specifies how the OSPF routing protocol can be applied between PE and CE routers in a Border Gateway Protocol/Multiprotocol Label Switching (BGP/MPLS) IP Virtual Private Network (VPN) environment. By defining extensions and procedures that integrate OSPF into the MPLS VPN model, this approach provides that customer routing domains remain isolated while still exchanging routing information seamlessly across the service provider's backbone. In practice, RFC 4577 is especially valuable for organizations that rely on OSPF in their internal networks and wish to extend those networks over a service provider's MPLS infrastructure. It enables service providers to offer scalable VPN services that support multiple customers'OSPF routing processes, ensuring routing consistency, isolation, and security for each VPN instance. As a result, RFC 4577 is commonly used to interconnect geographically dispersed sites, data centers, or branch offices requiring a robust, standards-based method of bridging OSPF networks with MPLS VPNs.

While the present disclosure uses RFC 4577 primarily to illustrate the issue of route redistribution, those skilled in the art will appreciate that the underlying problem is not limited to RFC 4577. The methods and systems described herein apply broadly to any scenario where routes are exchanged between different routing protocols—whether from Protocol A to Protocol B or vice versa—such that loop prevention information can be lost during the redistribution process. When the loop prevention information is stripped or not carried over properly, routing loops or incorrect path advertisements may arise, negatively impacting network stability and performance. By retaining and propagating key loop prevention information, the approach described herein provides for robust and reliable routing behavior, irrespective of the protocols involved in the redistribution. Also, this implementation is not limited to redistribution scenarios. For example, eBGP uses AS-Path to detect the routing loop in Multi ASN (autonomous system number) environment. If AS path information is lost or over-written along the path, then loop prevention information is lost. The proposed solution will be beneficial in these scenarios as well.

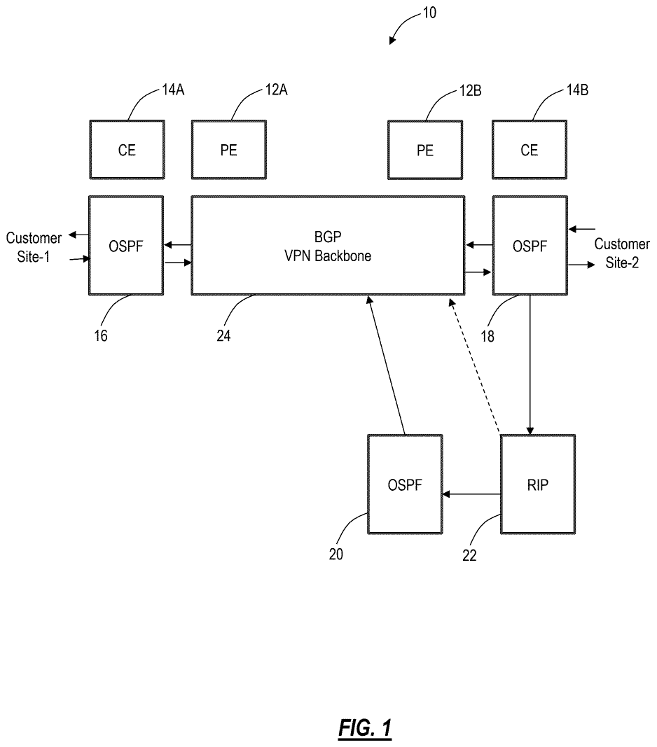

FIG. 1 illustrates a network 10 with PE routers 12A, 12B and CE routers 14A, 14B for illustrating different routing domains along with losing loss prevention information between routing domains. The network 10 shows four separate customer routing domains 16, 18, 20, 22—three OSPF domains 16, 18, 20 and one RIP domain 22—connecting through a central BGP/MPLS IP VPN backbone 24. Each domain 16, 18, 20, 22 t operates under its own routing instance or autonomous system. The BGP/MPLS IP VPN backbone 24 represents a service provider's core network, where the PE routers 12A, 12B exchange routes among themselves using BGP and employ MPLS to forward labeled packets. On the outer edges and below the backbone, the respective CE routers 14A, 14B run their internal routing protocols (OSPF or RIP), interfacing with the PE routers 12A, 12B at the provider boundary. Those skilled in the art understand the routing domains 16, 18, 20, 22 and the BGP/MPLS IP VPN backbone 24 are each a group of interconnected network devices under a single administrative authority or common routing policy. Within each domain, routers exchange routing information (for example, via OSPF, RIP, or BGP) to ensure that all devices understand how to reach one another. This shared routing information allows the domain to function as a cohesive system, even if it spans multiple physical locations.

Provider Edge (PE) Routers 12A, 12B: These are routers located at the edge of a service provider's network, the BGP/MPLS IP VPN backbone 24. Their primary role is to interface directly with customer networks via Customer Edge (CE) routers. PE routers maintain separate routing tables (often through Virtual Routing and Forwarding instances, or VRFs) for each customer, ensuring logical isolation among multiple VPNs.

Customer Edge (CE) Routers 14A, 14B: CE routers reside on the customer's premises and connect to the service provider's PE routers. They typically run routing protocols—such as OSPF or BGP—with the PE device in order to exchange routes. The CE router remains under the customer's administrative control and is responsible for managing the local network's traffic that enters or exits the VPN.

BGP/MPLS IP VPN Environment 24: In this setup, the service provider uses Multi-Protocol Label Switching (MPLS) in the core network to forward customer traffic efficiently and securely. BGP is used among PE routers to distribute VPN-related routing information. Each customer's routes are kept distinct, allowing multiple VPNs to coexist over the same MPLS backbone without interfering with one another.

Open Shortest Path First (OSPF): OSPF is an interior gateway protocol (IGP) that uses a link-state algorithm to compute shortest paths within a given autonomous system. It distributes information about network topology and link states, enabling routers to adapt quickly to network changes. When used as a PE-CE protocol, OSPF allows the customer to continue using its familiar internal routing method while extending connectivity over the provider's MPLS infrastructure.

Customer Routing Domains 16, 18, 20, 22: These are the distinct, isolated routing environments that belong to the same customer. Within the service provider network, every customer's routes are segregated—often by VRFs—so that they remain invisible to other customers. This logical separation guarantees privacy and prevents routing overlap.

Each OSPF domain 16, 18, 20 typically belongs to different sites of same customer or business unit. These OSPF domains 16, 18, 20 maintain their own link-state databases and compute shortest paths within their areas. At the boundary between each OSPF domain 16, 18, 20 and the provider's network, i.e., the BGP/MPLS IP VPN backbone 24, a PE router 12A, 12B translates OSPF routes into BGP updates, which are then propagated through the BGP/MPLS IP VPN backbone 24.

The BGP/MPLS IP VPN backbone 24 may be the provider's MPLS core network, where the PE routers 12A, 12B use BGP to exchange VPN routes. Virtual Routing and Forwarding (VRF) instances on the PE routers 12A, 12B keep customer routing information logically separate, ensuring traffic isolation among different VPNs. As routes enter the backbone, MPLS labels are assigned to forward packets efficiently. When routes exit the backbone toward a CE router 14A, 14B, they are translated back into the customer's preferred protocol (such as OSPF or RIP).

For illustrating the loop prevention problem, the network 10 includes an additional OSPF domain 20 and RIP domain 22. For example, the OSPF domain 20 can belong to another company site or a different part of the same organization. The RIP domain 22 is between the OSPF domains 18, 20, and uses a distance-vector protocol. Both these domains 20, 22 are likewise connected to the BGP/MPLS IP VPN backbone 24 via their own PE-CE links, where routing information undergoes a similar translation process.

In some network architectures, the service provider backbone (or an intermediate network segment) may use RIP or other protocols as a “third” routing domain between the two OSPF domains 18, 20. Because RIP is a distance-vector protocol and does not carry the same detailed link-state information as OSPF, certain advanced attributes—such as external route tags or link-state advertisements—may not be preserved when routes are translated from OSPF to RIP and then back to OSPF. This can introduce a risk of losing loop prevention or route attribute data, highlighting the need for careful network design and configuration to avoid routing loops or mismatched metrics. RIP is one of the oldest distance-vector routing protocols, originally specified in RFC 1058 and later updated in RIP Version 2 (RFC 2453). It uses hop count as its primary metric, with a maximum limit of 15 hops to prevent routing loops. Due to its simplicity, RIP is easy to implement in smaller networks but is generally less scalable and feature-rich than link-state protocols such as OSPF.

When traffic or routes move between two OSPF domains 18, 20 via the intermediate RIP domain 22, certain OSPF-specific attributes (such as external route tags) might not be preserved through the conversion to RIP. This conversion process—OSPF to BGP to RIP, and then back to OSPF—can potentially strip or alter loop prevention information or detailed link-state attributes, requiring careful design to avoid routing loops or inaccurate metrics.

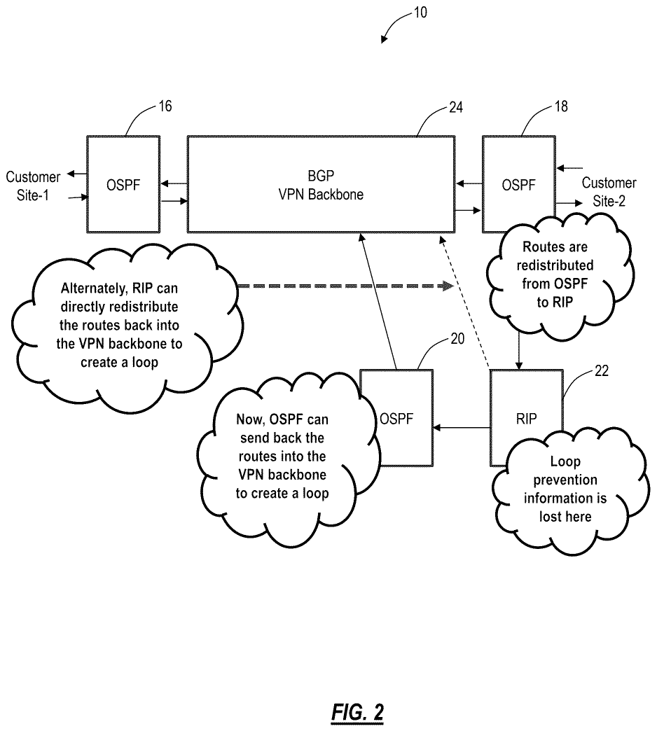

FIG. 2 illustrates the network 10 showing the loop prevention problem with the intermediate RIP domain 22. When routes are redistributed from BGP into OSPF, they carry crucial loop prevention information—such as the OSPF ‘DN’ (Down) bit or a dedicated “VPN route tag”—which tells OSPF not to readvertise these routes back into the BGP VPN backbone. However, if these same routes are subsequently redistributed from OSPF into a different protocol (e.g., RIP, etc.), that loop prevention metadata can be stripped away if the third protocol does not support or preserve it. Losing this information removes the safeguards preventing the route from looping, and thus the affected route can be inadvertently readvertised from the third protocol—or even reintroduced to OSPF and then on to the BGP VPN backbone—creating routing loops. As highlighted in RFC 4577 Section 4.2.5.3, this risk is not unique to OSPF and BGP; any multi-protocol redistribution scenario where loop-preventing attributes are lost during translation faces the same vulnerability.

Specifically, in addition to RIP, any routing protocol that does not maintain an equivalent “tag” or bit to store OSPF's loop prevention information (e.g., the OSPF DN bit or VPN route tag) risks discarding that data during redistribution. Common examples include:
(1) RIP (Routing Information Protocol)—A simple distance-vector protocol that uses hop count as its metric. RIP has no built-in mechanism to carry over OSPF route tags or DN bits, so once an OSPF route is redistributed into RIP, the loop prevention metadata is lost.
(2) IGRP (Interior Gateway Routing Protocol)—An older Cisco proprietary protocol (predecessor to EIGRP). It lacks standardized route tags that could preserve the OSPF metadata.
(3) Some EIGRP Configurations—Although EIGRP supports route tagging, it may not preserve or recognize OSPF-specific attributes (like the DN bit) by default. If route tags are not correctly mapped or configured, OSPF's loop prevention information can be dropped.
(4) Older or Proprietary Protocols—Any legacy or specialized protocol that lacks a compatible tag field (or whose implementation does not map OSPF's DN bit) will also fail to preserve the loop prevention information.

To address this loss of loop prevention information or metadata, the present disclosure designates a “special” route or prefix on the PE routers 12A, 12B running BGP, propagate it alongside normal routes through each redistribution step, and use it as a signature to detect when routing information has leaked back into the VPN backbone without the usual loop prevention tags (DN bit, VPN route tag, etc.). A “special” route or prefix on the PE routers 12A, 12B running BGP refers to a uniquely chosen IP address (or subnet) that is injected into the routing domain for the explicit purpose of detecting routing loops. Unlike ordinary prefixes—which represent actual customer or infrastructure networks—this special prefix:
(1) Does Not Overlap—It is selected to avoid any overlap with existing production routes, so that it will not inadvertently influence normal data traffic. For example, a special prefix can be said to not overlap with a production route when it does not match the prefix for that production route.
(2) Carries Loop-Prevention Metadata—When the special route (e.g., associated with or including the special prefix) is redistributed from BGP into another routing protocol (e.g., OSPF), it can carry loop-prevention attributes such as the OSPF DN bit or a VPN route tag.
(3) Acts as a “Marker”—Because this special prefix does not normally appear in the real network, the PE router can easily recognize it if it returns from a customer edge (CE) router—indicating that the associated route has looped through some external (third) protocol that dropped its loop-prevention metadata.
(4) Triggers Detection and Mitigation—Upon seeing the special prefix reappear with missing or invalid loop-prevention data, the PE router infers that a routing loop is formed. It can then log an alarm, suspend redistribution of routes, or take other corrective actions to prevent further loop propagation.

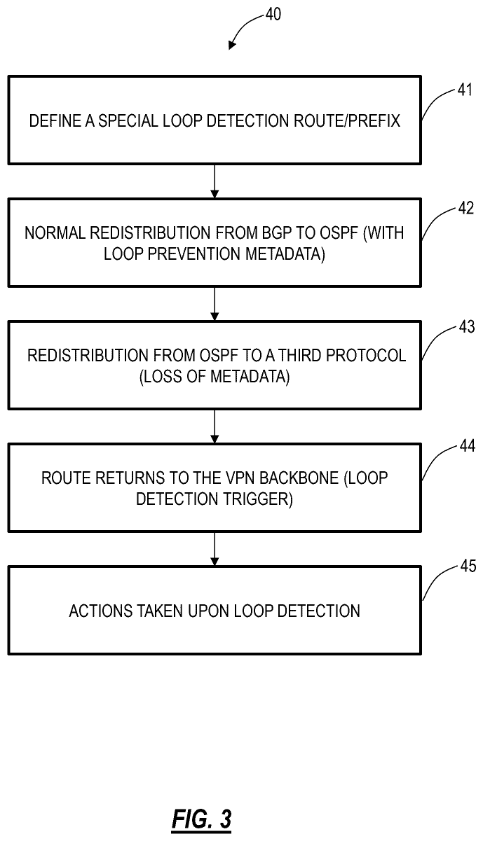

FIG. 3 is a flowchart of a process 40 detailing associated steps for loop prevention with the special loop detection route/prefix. The process 40 contemplates implementation as a method with steps, via the PE router 12A, 12B, and as a non-transitory computer-readable medium storing instructions that, when executed, cause circuitry to implement the steps. The steps are as follows:
(1) Define a Special Loop detection Route/Prefix (step 41), e.g., a.b.c.d/32. An address in the format a.b.c.d/32 denotes a single IPv4 host address rather than a range of addresses. The “/32” portion, often referred to as the subnet mask length (in classless inter-domain routing (CIDR) notation), specifies that all 32 bits of the IP address are fixed for the network portion. On each PE router 12A, 12B participating in the BGP/MPLS IP VPN backbone 24, configure a unique prefix that does not overlap with any existing customer or infrastructure routes or prefixes. This prefix, or a special route that includes this prefix, or a combination thereof, will act as a “marker” to detect loops. In some implementations, this special route/prefix can be automatically generated from the PE router's 12A, 1B BGP parameters, removing the need for manual configuration.
(2) Normal Redistribution from BGP to OSPF (With Loop prevention Metadata) (step 42). When the PE router 12A. 12N redistributes BGP routes into OSPF, ensure the special loop detection route/prefix is also included. At this point, the special route (and all normal routes) carries valid loop prevention metadata, such as the OSPF Down (DN) bit or a VPN route tag. Within the OSPF domain 16. 18. 20, the DN bit or VPN route tag continues to signal that these routes originated from a BGP VPN context, thereby preventing them from being readvertised back into the backbone directly.
(3) Redistribution from OSPF to a Third Protocol (Loss of Metadata) (step 43). Re: Losing the DN Bit or VPN Tag, when OSPF routes are subsequently redistributed into a third protocol (e.g., RIP, etc.), the loop prevention data may be lost if that protocol does not support equivalent tagging mechanisms. The special route thus becomes “tag-less” (or DN-bit-less) in the third protocol domain.
(4) Route Returns to the VPN Backbone (Loop Detection Trigger) (step 44). If this newly “tag-less” route (including the special prefix) is eventually redistributed back toward the PE router 12A, 12B—either directly from the third protocol or re-injected via OSPF—there is no loop prevention information attached to it. Upon receiving a route from the customer edge (CE), the PE router 12A, 12B checks: “Is the received route the same as (or does it include or otherwise correspond to) the special loop detection prefix configured locally?” If Yes, the PE router 12A, 12B concludes that a loop is present (because the special route it advertised previously has returned without its original loop prevention attributes).
(5) Actions Taken Upon Loop Detection (step 45)—
(a) Report the Event—Once the loop is detected, the PE router 12A, 12B can generate an alarm or notification—via Syslog, simple network management protocol (SNMP) trap, telemetry, or any other preferred monitoring mechanism—alerting network administrators to the loop condition.
(b) Suspend Redistribution (Optional)—The PE router 12A, 12B can suspend further redistribution of routes into the VPN backbone until the loop condition clears. This prevents continuous looping of data and protects the core network from potential routing instability. Alternatively, in some implementations, the administrator may choose to only raise an alarm without blocking redistribution, depending on operational requirements.

General Applicability of the process 40:
(1) Addresses RFC4577 Loop Issue—This proposal directly targets the scenario described in RFC 4577 Section 4.2.5.3, where routes lose their DN bit or VPN route tag after redistribution into a third routing protocol and then loop back.
(2) Simple and Effective—By relying on a unique marker prefix, this solution provides a straightforward method to detect when a route has circumvented normal loop prevention safeguards.
(3) Extensible Beyond RFC 4577—Although inspired by RFC 4577 (OSPF as the PE-CE protocol), the same principle applies any time routes are redistributed between protocols that do not mutually preserve loop prevention tags. Again, this implementation is not limited to redistribution scenarios. For example, eBGP uses AS-Path to detect the routing loop in Multi ASN (autonomous system number) environment. If AS path information is lost or over-written along the path then loop prevention information is lost. The proposed solution will be beneficial in this scenarios as well.

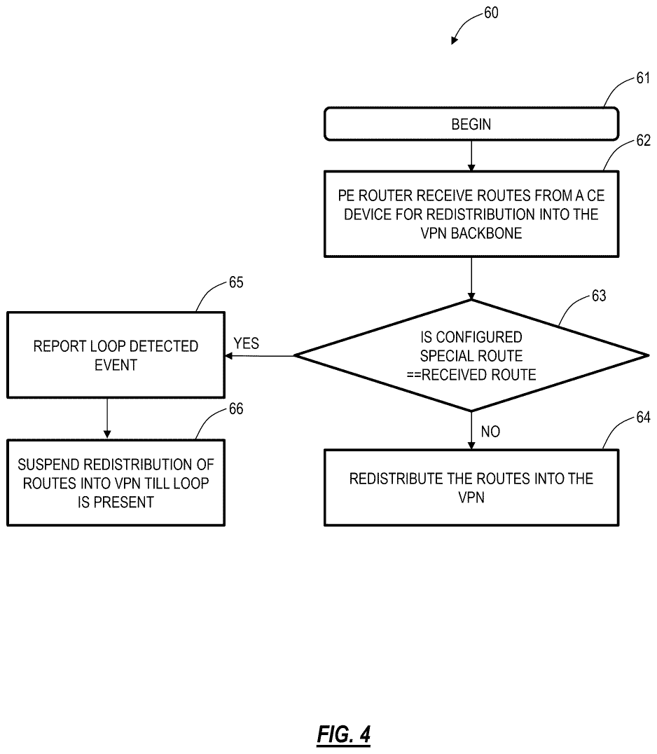

FIG. 4 is a flowchart of a process 60 describing redistribution of routes and prevention of loops using the special route/prefix from the process 40. Similar to the process 40, the process 60 contemplates implementation as a method with steps, via the PE router 12A, 12B, and as a non-transitory computer-readable medium storing instructions that, when executed, cause circuitry to implement the steps.

The process 60 begins (step 61) monitoring for routes received from the CE (step 62), namely the PE router 12A, 12B receives various customer routes (including the special route), which it may advertise into the BGP VPN backbone. The process 60 checks for the special route (step 63), namely, before redistributing into the backbone, the PE router 12A, 12B checks if any route matches (e.g., includes) the locally configured special prefix. If the check at step 63 results in No Match, normal operation proceeds; the PE router 12A, 12B redistributes the route into the VPN, tagging it as necessary (step 64). If the check at step 63 results in a Match Found (Yes), a match indicates the route has looped back without its original loop prevention tags. The PE router 12A, 12B reports a “Loop Detected” event (step 65) and optionally suspends redistribution of those routes to prevent further looping (step 66). By following the steps in the process 60, service providers and network operators can detect and mitigate routing loops that occur when critical loop prevention information (DN bit, VPN tag) is stripped away by third-party protocols. This mechanism ensures that even in environments mixing BGP, OSPF, RIP, or other protocols, accidental reintroduction of routes into the VPN backbone does not go unnoticed.

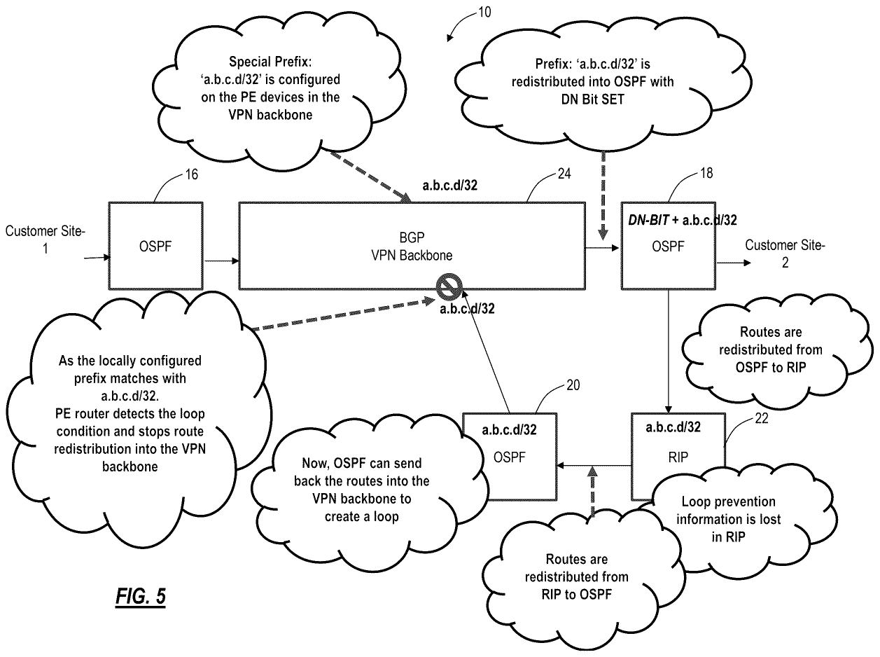

FIG. 5 illustrates the network 10 showing the loop prevention problem with the intermediate RIP domain 22, along with operation of the processes 40, 60 addressing loop prevention with the special route.

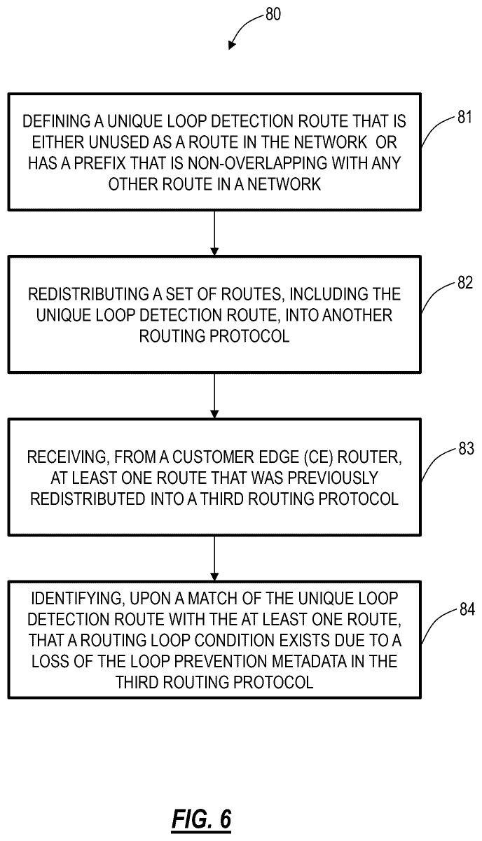

FIG. 6 is a flowchart of a process 80 describing loop detection and prevention in a network with a multi-protocol routing environment. Similar to the processes 40, 60, the process 80 contemplates implementation as a method with steps, via the PE router 12A, 12B, and as a non-transitory computer-readable medium storing instructions that, when executed, cause circuitry to implement the steps.

The process 80 includes defining a unique loop detection route that is either unused as a route in the network or has a prefix that is non-overlapping with any other route in the network (step 81); redistributing a set of BGP routes, including the unique loop detection route, into another routing protocol, thereby attaching loop prevention metadata to the redistributed routes (step 82); receiving, from a customer edge (CE) router, at least one route that was previously redistributed into a third routing protocol (step 83); and identifying, upon a match of the unique loop detection route with the at least one route, that a routing loop condition exists due to a loss of the loop prevention metadata in the third routing protocol (step 84).

The process 80 can further include generating an alert upon identifying the routing loop condition, wherein the alert is: a Syslog message; a simple network management protocol (SNMP) trap; a telemetry notification; or an event log entry. The process 80 can further include suspending redistribution into a BGP virtual private network (VPN) backbone upon identifying the routing loop condition, thereby preventing recirculation of looped routes. The process 80 can further include re-enabling redistribution of routes into the BGP VPN backbone once the routing loop condition clears, wherein clearing is determined by the absence of the unique loop detection route in subsequent route updates from the CE router, such as for a predetermined or configurable time duration.

The loop prevention metadata attached in another routing protocol include at least one of: a Down (DN) bit in Open Shortest Path First (OSPF), or a VPN route tag. The third routing protocol through which the loop prevention metadata is lost is selected from the group consisting of: routing information protocol (RIP), interior gateway routing protocol (IGRP), enhanced interior gateway routing protocol (EIGRP) in configurations that do not preserve route tags, and a proprietary or legacy distance-vector protocol lacking support for the loop prevention metadata.

The process 80 can further include automatically deriving the unique loop detection route from existing BGP configuration parameters on the PE router, thereby eliminating the need for manual configuration of the special route or prefix. The process 80 can further include recording the identified routing loop event in a data store accessible by a network management system, wherein the recorded information includes at least a timestamp, an identifier of the detecting PE router, and an indication of the unique loop detection route. Identifying the routing loop condition further includes detecting an absence or alteration of the original loop prevention metadata on the at least one route when it is received from the CE router. The process 80 can further include applying the defined unique loop detection route and loop prevention metadata to multiple routing protocols concurrently, such that each protocol's redistributed routes are checked for the unique loop detection prefix, ensuring comprehensive loop detection across different routing protocols.

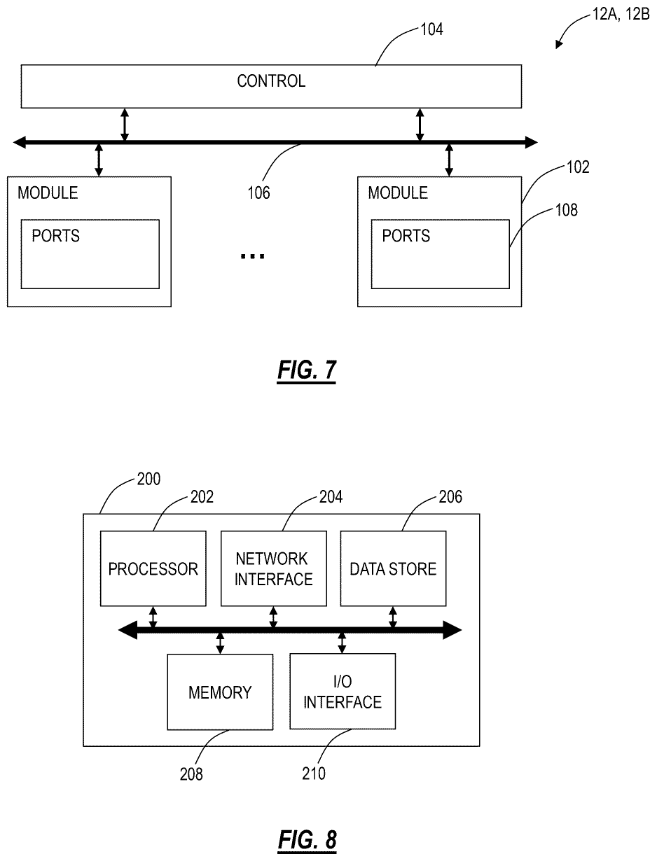

FIG. 7 illustrates a block diagram of a PE router 12A, 12B, depicted in a simplified functional format. It is important to note that a more practical design of this router would likely include additional components and processing logic to accommodate standard operating features, which are not detailed here. The router 12A, 12B may represent any network element operable in a network using optical and packet protocols, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the router 12A, 12B. It may also communicate with external network management systems or databases that handle provisioning and operational data.

Lastly, while FIG. 7 provides a basic view, those skilled in the art will understand that the router 12A, 12B could include additional components or be configured differently, such as in a distributed arrangement or as an integrated, rack-mounted unit (often referred to as a “pizza-box” configuration). This depiction in FIG. 7 is intended to convey functional aspects, with actual hardware implementations varying widely.

FIG. 8 illustrates a block diagram of an example processing device 200. The processing device 200 may be integrated within the router 12A, 12B or function as a standalone unit connected to the router 12A, 12B. It may also be known as an apparatus, a control module, shelf controller, shelf processor, or system controller. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, operations, administration, maintenance, and provisioning (OAM&P) data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method, implemented at a provider edge (PE) router, for detecting and preventing routing loops in a network with a multi-protocol routing environment, the method comprising steps of:
defining a unique loop detection route that is either unused as a route in the network or has a prefix that is non-overlapping with any other route in a network;
redistributing a set of routes, including the unique loop detection route, into another routing protocol;
receiving, from a customer edge (CE) router, at least one route that was previously redistributed into a third routing protocol; and
identifying, upon a match of the unique loop detection route with the at least one route, that a routing loop condition exists due to a loss of the loop prevention metadata in the third routing protocol.

2. The method of claim 1, wherein the steps further include
generating an alert upon identifying the routing loop condition, wherein the alert is: a Syslog message; a simple network management protocol (SNMP) trap; a telemetry notification; or an event log.

3. The method of claim 1, wherein the steps further include
suspending redistribution into a border gateway protocol (BGP) virtual private network (VPN) backbone upon identifying the routing loop condition, thereby preventing recirculation of looped routes.

4. The method of claim 3, wherein the steps further include
re-enabling redistribution of routes into the BGP VPN backbone once the looped routes clear, wherein clearing is determined by an absence of the unique loop detection route in subsequent route updates from the CE router, for a predetermined or configurable time duration.

5. The method of claim 1, wherein the loop prevention metadata attached in the another routing protocol include at least one of: a Down (DN) bit in Open Shortest Path First (OSPF); a VPN route tag; or any other loop prevention information.

6. The method of claim 1, wherein the third routing protocol through which the loop prevention metadata is lost is one of: border gateway protocol (BGP), routing information protocol (RIP), interior gateway routing protocol (IGRP), enhanced interior gateway routing protocol (EIGRP) in configurations that do not preserve the loop prevention metadata, or a proprietary or legacy distance-vector protocol lacking support for the loop prevention metadata.

7. The method of claim 1, wherein the steps further include
automatically deriving the unique loop detection route from existing border gateway protocol (BGP) configuration parameters on the PE router, thereby eliminating manual configuration of the prefix.

8. The method of claim 1, wherein the steps further include
recording the routing loop condition in a data store accessible by a network management system, wherein the recording includes at least a timestamp, an identifier of the detecting PE router, and an indication of the unique loop detection route.

9. The method of claim 1, wherein identifying the routing loop condition further includes detecting an absence or alteration of the loop prevention metadata on the at least one route when it is received from the CE router, for a predetermined or configurable time duration.

10. The method of claim 1, wherein the steps further include
applying the defined unique loop detection route and loop prevention metadata to multiple routing protocols concurrently, such that each protocol's redistributed routes are checked for the unique loop detection prefix.

11. A provider edge (PE) router, configured for detecting and preventing routing loops in a network with a multi-protocol routing environment, the PE router comprising circuitry configured to:
define a unique loop detection route that is either unused as a route in the network or has a prefix that is non-overlapping with any other route in a network,
redistribute a set of routes, including the unique loop detection route, into another routing protocol,
receive, from a customer edge (CE) router, at least one route that was previously redistributed into a third routing protocol, and
identify, upon a match of the unique loop detection route with the at least one route, that a routing loop condition exists due to a loss of the loop prevention metadata in the third routing protocol.

12. The PE router of claim 11, wherein the circuitry is further configured to
generate an alert upon identifying the routing loop condition, wherein the alert is: a Syslog message; a simple network management protocol (SNMP) trap; a telemetry notification; or an event log entry.

13. The PE router of claim 11, wherein the circuitry is further configured to
suspend redistribution into a border gateway protocol (BGP) virtual private network (VPN) backbone upon identifying the routing loop condition, thereby preventing recirculation of looped routes.

14. The PE router of claim 11, wherein the circuitry is further configured to
re-enable redistribution of routes into a border gateway protocol (BGP) VPN backbone once the looped routes clear, wherein clearing is determined by an absence of the unique loop detection route in subsequent route updates from the CE router, for a configurable time duration.

15. The PE router of claim 11, wherein the loop prevention metadata attached in the another routing protocol include at least one of: a Down (DN) bit in Open Shortest Path First (OSPF); a VPN route tag; or any other loop prevention information.

16. The PE router of claim 11, wherein the third routing protocol through which the loop prevention metadata is lost is selected from the group consisting of: routing information protocol (RIP), interior gateway routing protocol (IGRP), enhanced interior gateway routing protocol (EIGRP) in configurations that do not preserve route tags, and a proprietary or legacy distance-vector protocol lacking support for the loop prevention metadata.

17. The PE router of claim 11, wherein the circuitry is further configured to
automatically derive the unique loop detection route from existing border gateway protocol (BGP) configuration parameters on the PE router, thereby eliminating manual configuration of the prefix.

18. A non-transitory computer-readable medium comprising instructions for detecting and preventing routing loops in a network with a multi-protocol routing environment, the instructions, when executed by a provider edge (PE) router, cause the PE router to perform steps of:
defining a unique loop detection route that is either unused as a route in the network or has a prefix that is non-overlapping with any other route in a network;
redistributing a set of routes, including the unique loop detection route, into another routing protocol;
receiving, from a customer edge (CE) router, at least one route that was previously redistributed into a third routing protocol; and
identifying, upon a match of the unique loop detection route with the at least one route, that a routing loop condition exists due to a loss of the loop prevention metadata in the third routing protocol.

19. The non-transitory computer-readable medium of claim 18, wherein the steps further include
generating an alert upon identifying the routing loop condition, wherein the alert is: a Syslog message; a simple network management protocol (SNMP) trap; a telemetry notification; or an event log entry.

20. The non-transitory computer-readable medium of claim 18, wherein the steps further include
suspending redistribution into a border gateway protocol (BGP) virtual private network (VPN) backbone upon identifying the routing loop condition, thereby preventing recirculation of looped routes.
